(19) United States
(12) Patent Application Publication
(10) Pub. No.: US 2023/0122429 A1
(43) Pub. Date: Apr. 20, 2023

(54) SUMMARIZATION OF CUSTOMER SERVICE DIALOGS

(71) Applicant: International Business Machines Corporation, Armonk, NY (US)

(72) Inventors: Chulaka Gunasekara, New Hyde Park, NY (US); Sachindra Joshi, Gurgaon (IN); Guy Feigenblat, Givataym (IL); Benjamin Sznajder, Jerusalem (IL); David Konopnicki, Haifa (IL)

(21) Appl. No.: 17/503,313

(22) Filed: Oct. 17, 2021

(51) Int. Cl. G06Q 30/00; G06N 20/00; G06N 7/00

(52) U.S. Cl. CPC G06Q 30/016; G06N 20/00; G06N 7/005

(57) ABSTRACT

Summarization of customer service dialogs by: receiving, as input, a two-party multi-turn dialog; applying a trained next response prediction (NRP) machine learning model to the received dialog, to determine a level of significance of each utterance in the dialog with respect to performing an NRP task over the dialog; assigning a score to each of the utterances in the dialog, based, at least in part, on the determined level of significance; and selecting one or more of the utterances for inclusion in an extractive summarization of the dialog, based, at least in part, on the assigned scores.

### BACKGROUND

The invention relates to the field automated text summarization.

Text summarization is the task of creating a short version of a long text, while retaining the most important or relevant information. Many current summarization models largely focus on documents such as news and scientific publications. However, automated text summarization may also be useful in other domains, such as summarization of conversational or dialog exchanges between humans.

For example, in customer care settings, a typical customer service chat scenario begins with a customer who contacts a support center to ask for help or raise complaints, where a human agent attempts to solve the issue. In most cases, at the end of the conversation, agents are asked to write a short summary emphasizing the problem and the proposed solution, usually for the benefit of other agents that may have to deal with the same customer or issue. Accordingly, it would be advantageous to provide for the automation of this task, so as to relieve customer care agents from the need to manually create summaries of their conversations with customers.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, as input, a two-party multi-turn dialog, apply a trained next response prediction (NRP) machine learning model to the received dialog, to determine a level of significance of each utterance in the dialog with respect to performing an NRP task over the dialog, assign a score to each of the utterances in the dialog, based, at least in part, on the determined level of significance, and select one or more of the utterances for inclusion in an extractive summarization of the dialog, based, at least in part, on the assigned scores.

There is also provided, in an embodiment, a computer-implemented method comprising: receiving, as input, a two-party multi-turn dialog; applying a trained next response prediction (NRP) machine learning model to the received dialog, to determine a level of significance of each utterance in the dialog with respect to performing an NRP task over the dialog; assigning a score to each of the utterances in the dialog, based, at least in part, on the determined level of significance; and selecting one or more of the utterances for inclusion in an extractive summarization of the dialog, based, at least in part, on the assigned scores.

There is further provided, in an embodiment, a computer program product comprising a non-transitory computer-readable storage medium having program instructions embodied therewith, the program instructions executable by at least one hardware processor to: receive, as input, a two-party multi-turn dialog; apply a trained next response prediction (NRP) machine learning model to the received dialog, to determine a level of significance of each utterance in the dialog with respect to performing an NRP task over the dialog; assign a score to each of the utterances in the dialog, based, at least in part, on the determined level of significance; and select one or more of the utterances for inclusion in an extractive summarization of the dialog, based, at least in part, on the assigned scores.

In some embodiments, the dialog represents a conversation between a customer and a customer care agent.

In some embodiments, the NRP task comprises predicting, from a provided set of candidate utterances, one of: (i) a next utterance at a specified point in the dialog, based on an input dialog context comprising a sequence of utterances appearing in the dialog before the specified point; and (ii) a previous utterance at a specified point in the dialog, based on an input dialog context comprising a sequence of utterances appearing in the dialog after the specified point.

In some embodiments, the predicting is associated with a probability.

In some embodiments, with respect to an utterance of the utterances, the level of significance is determined by calculating a difference between (i) the probability associated with the predicting when the utterance is included in the dialog context, and (ii) the probability associated with the predicting when the utterance is excluded from the dialog context.

In some embodiments, the selecting comprises selecting the utterances having a score exceeding a specified threshold.

In some embodiments, the NRP machine learning model is trained on a training dataset comprising a plurality of entries, wherein each of the entries comprises: (i) a dialog context comprising a sequence of utterances appearing in a dialog prior to specified point; (ii) a candidate next utterance; and (iii) a label indicating whether the candidate next utterance is the correct next utterance in the dialog.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a block diagram of an exemplary system for automated generation of summaries of conversational exchanges or dialogs, specifically, between customers and human support agents, according to some embodiments of the present disclosure; and

FIG. 2 is a flowchart of the functional steps in a method for automated generation of summaries of conversational exchanges or dialogs, specifically, between customers and human support agents, according to some embodiments of the present disclosure.

### DETAILED DESCRIPTION

Disclosed herein is a technique, embodied in a system, method, and computer program product, for automated generation of summaries of conversational exchanges or dialogs, specifically, between customers and human support agents.

As noted above, in customer care settings, a typical customer service chat scenario begins with a customer who contacts a support center to ask for help or raise complaints, where a human agent attempts to solve the issue. In many enterprises, once an agent is done with handling a customer request, the agent is required to create a short summary of the conversation for record keeping purposes. At times, an ongoing conversation may also need to be transferred to another agent or escalated to a supervisor. This also requires creating a short summary of the conversation up to that point, so as to provide the right context to the next handling agent. In some embodiments, the present disclosure provides of the automation of this task.

Text summarization is the task of creating a short version of a long text, while retaining the most important or relevant information. In natural language processing (NLP), it is common to recognize two types of summarization tasks:
Extractive summarization: Selecting salient segments from the original text to form a summary.
Abstractive summarization: Generating new natural language expressions which summarize the text.

In some embodiments, the present disclosure provides for an unsupervised extractive summarization algorithm for summarization of dialogs. In some embodiments, the summarization task of the present disclosure concerns multi-turn two-party conversations between humans, and specifically, between customers and human support agents.

In some embodiments, the present unsupervised extractive summarization is based, at least in part, on identifying the sentences or utterances in the dialog which influence the entire conversation the most. In some embodiments, the influence of each utterance and/or sentence within a dialog on the conversation is determined based, at least in part, on a prediction model configured to perform a next response prediction (NRP) task in conjunction with dialog systems.

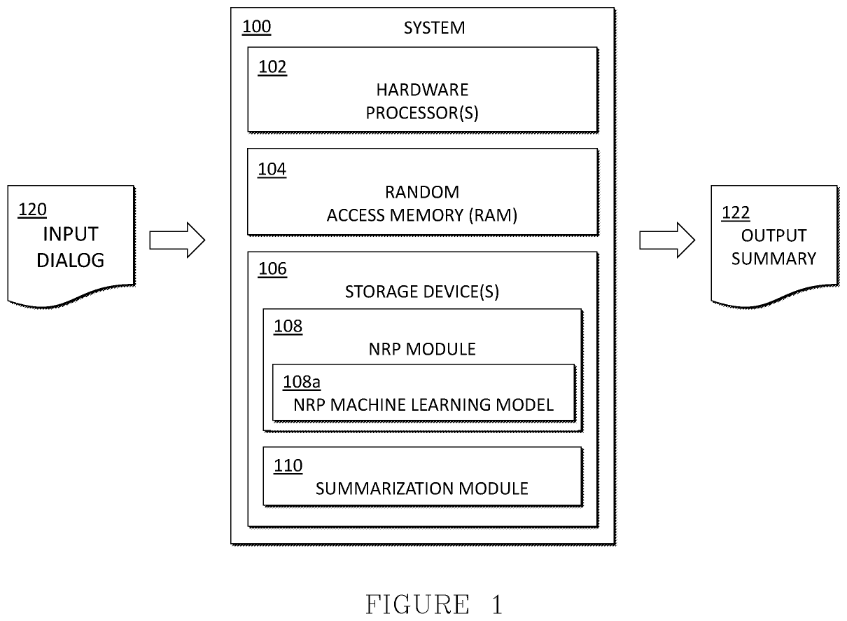

FIG. 1 shows a block diagram of an exemplary system 100 for automated generation of summaries of conversational exchanges or dialogs, specifically, between customers and human support agents, according to some embodiments of the present disclosure. System 100 may include one or more hardware processor(s) 102, a random-access memory (RAM) 104, and one or more non-transitory computer-readable storage device(s) 106. Components of system 100 may be co-located or distributed, or the system may be configured to run as one or more cloud computing ‘instances,’ ‘containers,’ ‘virtual machines,’ or other types of encapsulated software applications, as known in the art.

Storage device(s) 106 may have stored thereon program instructions and/or components configured to operate hardware processor(s) 102. The program instructions may include one or more software modules, such as a next response prediction (NRP) module 108 and/or a summarization module 110. The software components may include an operating system having various software components and/or drivers for controlling and managing general system tasks (e.g., memory management, storage device control, power management, etc.), and facilitating communication between various hardware and software components. System 100 may operate by loading instructions of NRP module 108 and/or a summarization module 110 into RAM 104 as they are being executed by processor(s) 102.

In some embodiments, the instructions of NRP module 108 may cause system 100 to receive an input dialog 120, and process it to determine a level of influence of each sentence and/or utterance within the dialog over the entire conversation. In some embodiments, NRP module 108 may employ one or more trained machine learning models, wherein the one or more trained machine learning models may be trained using a training dataset comprising positive and negative examples with cross-entropy loss. In some embodiments, the one or more trained machine learning models may be configured to predict, e.g., a next response in a dialog given one or more prior utterance in the dialog, and/or predict a preceding utterance within a dialog given one or more subsequent utterances in the dialog.

In some embodiments, the instructions of summarization module 110 may cause system 100 to receive an input dialog 120 and/or the output of NRP module 108, and to output an extractive summary 122 of dialog 120.

In some embodiments, system 100 may include one or more databases, which may be any suitable repository of datasets, stored, e.g., on storage device(s) 106. In some embodiments, system 100 may employ any suitable one or more natural language processing (NLP) algorithms, used to implement an NLP system that can determine the meaning behind a string of text or voice message and convert it to a form that can be understood by other applications. In some embodiments, an NLP algorithm includes a natural language understanding component. In some embodiments, input dialog 120 and summary 122 may be obtained and/or implemented using any suitable computing device, e.g., without limitation, a smartphone, a tablet, computer kiosk, a laptop computer, a desktop computer, etc. Such device may include a user interface that can accept user input from a customer.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 100 may be co-located or distributed, or the system may be configured to run as one or more cloud computing ‘instances,’ ‘containers,’ ‘virtual machines,’ or other types of encapsulated software applications, as known in the art. As one example, system 100 may in fact be realized by two separate but similar systems, e.g., one with NRP module 108 and the other with summarization module 110. These two systems may cooperate, such as by transmitting data from one system to the other (over a local area network, a wide area network, etc.), so as to use the output of one module as input to the other module.

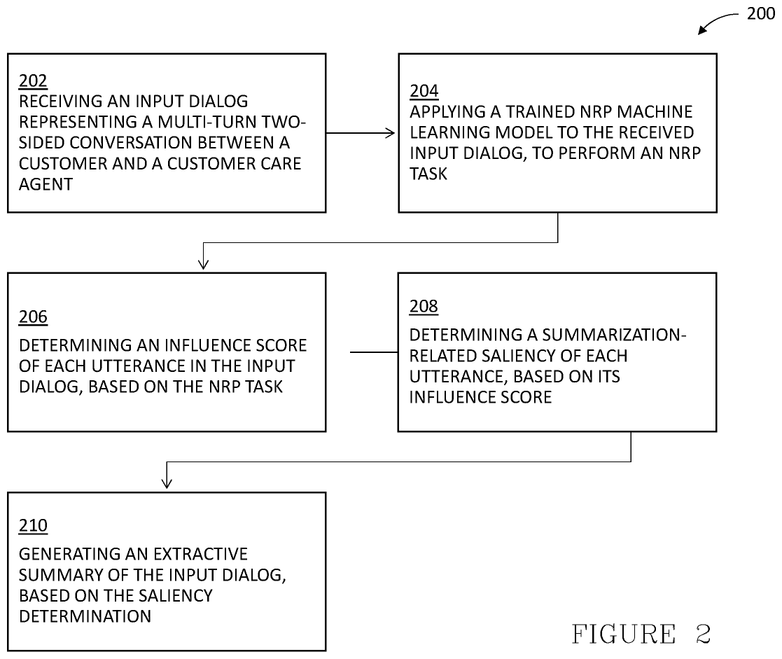

The instructions of NRP module 108 and/or a summarization module 110 will now be discussed with reference to the flowchart of FIG. 2, which illustrates the functional steps in a method 200 for automated generation of summaries of conversational exchanges or dialogs, specifically, between customers and human support agents, according to some embodiments of the present disclosure. The various steps of method 200 may either be performed in the order they are presented or in a different order (or even in parallel), as long as the order allows for a necessary input to a certain step to be obtained from an output of an earlier step. In addition, the steps of method 200 may be performed automatically (e.g., by system 100 of FIG. 1), unless specifically stated otherwise.

In some embodiments, in step 202, the instructions of NRP module 108 may cause system 100 to receive, as input, a dialog 120. Input dialog 120 may represent a two-party multi-turn conversation. In some embodiments, input dialog 120 may be a two-party multi-turn conversation between a customer and a customer care agent. For example, the following exemplary input dialog 120 represents a series of exchanges between a customer and an airline customer care agent concerning an issue with a flight:

| | |
|---|---|
| Customer | Flight 1234 from Miami to LaGuardia smells awful. We just |
| | boarded. It's really really bad. |
| Agent | Allie, I am very sorry about this. Please reach out to a flight |
| | attendant to address the odor in the aircraft. |
| Customer | They're saying it came in from the last flight. They have |
| | sprayed and there's nothing else they can do. It's gross! |
| Agent | I'm very sorry about the discomfort this has caused you for |
| | your flight! |
| Customer | It's not just me! Every person getting on the flight is |
| | complaining. The smell is horrific. |
| Agent | Oh no, Allie. That's not what we want to hear. Please seek |
| | for one of our crew members on duty for further immediate |
| | assistance regarding this issue. Please accept our sincere |
| | apologies. |
| Customer | They've brought maintenance aboard. Not a great first |
| | class experience :( |
| Agent | We are genuinely sorry to hear about your disappointment, |
| | Allie. Hopefully, our maintenance crew can fix the issue |
| | very soon. Once again please accept our sincere apologies |
| | for this terrible incident. |
| Customer | Appreciate it. Thank you! |
| Agent | You are most welcome, Allie. Thanks for tweeting us today. |
| Customer | They told us to rebook, then told us the original flight was |
| | still departing. We got put back on 1234 but are now in the 1^{st} |
| | row instead of the 3^{rd}. Can you get us back in seats 3C and |
| | 3D? |
| Customer | My boyfriend is 6 feet tall and can't sit comfortably at the |
| | bulkhead. |
| Agent | Unfortunately, our First Class Cabin is full on our 1234 flight |
| | for today, Allie. You may seek further assistance by reaching |
| | out to one of our in-flight crew members on duty. |

In some embodiments, in step 204, the instructions of NRP module 108 may cause system 100 to inference a trained NRP machine learning model 108a over input dialog 120, to perform an NRP task.

In some embodiments, NRP machine learning model 108a is trained on a training dataset comprising a dialog corpus of conversations. In some embodiments, NRP machine learning model 108a may be configured to perform an NRP task with respect to input dialog 120. In some embodiments, the NRP task may be defined as follows: given a dialog context (C={s₁, s₂, sₖ}), i.e., a set or sequence of utterances within a dialog appearing before a specified point, predict the next response utterance (cᵣ) from a given set of candidates {c₁, . . . , cᵣ, . . . , cₙ}.

In some embodiments, the training dataset used to train NRP machine learning model 108a may comprise multiple entries, each comprising (i) a dialog context (e.g., a sequence of utterances appearing in a dialog prior to target response), (ii) a candidate next response, and (iii) a label which indicates whether or not the response is the actual correct next utterance after the given context (e.g., a binary label indicating 1/0, true/false, or yes/no). Within the training dataset, at least some of the plurality of entries may be duplicated two or more times, such that for each given dialog context, there are provided two or more entries: one with the actual true next utterance in the dialog response (wherein the label is set to, e.g., ‘1,’ ‘true,’ or ‘yes’), and one or more each with a random false response (wherein the label is set to ‘0,’ ‘false,’ or ‘no’).

Accordingly, in some embodiments, a training dataset of the present disclosure may comprise a plurality of entries, each comprising dialog context (C), candidate response (cᵢ), and a label (1/0). In some embodiments, for each C, the training dataset may include a set of k+1 (wherein k may be equal to 2, 5, 10, or more) entries: one entry containing the correct response (cᵣ) (label=1), and k entries containing incorrect responses randomly sampled from the dataset (label=0). In some embodiments, the present disclosure provides for training two versions of NRP machine learning models 108a: (i) an NRP machine learning model version which predicts a next response given prior dialog context (termed, e.g., NRP-FW), and (ii) an NRP machine learning model which predicts a previous utterance given subsequent utterances (termed, e.g., NRP-BW). An example entry pair in a training dataset of the present disclosure is shown in Table 1 below.

TABLE 1
Exemplary training dataset entry pair

| Dialog Context | Candidate Response | Label |
|---|---|---|
| I would like to receive a refund | My customer ID is 123456789 | 1 |
| of the purchase price | | |
| Could you please provide your | | |
| customer ID? | | |
| I would like to receive a refund | I am leaving on a trip | 0 |
| of the purchase price | tomorrow | |
| Could you please provide your | | |
| customer ID? | | |

In some embodiments, the instructions of NRP module 108 may cause system 100 to train NRP machine learning model 108a on the training dataset constructed as detailed immediately above. In some embodiments, during inference, the trained NRP machine learning model 108a is configured to associate a probability (pᵣ) with a candidate response (cᵣ), given the dialog context C.

In some embodiments, in step 206, NRP machine learning model 108a created in step 204 may then be applied to input dialog 120, to determine an influence score of each utterance within input dialog 120. In some embodiments, an influence score of an utterance within input dialog 120 may be defined as a level of significance of the utterance (when part of a given context) to performing an NRP task over dialog 120 by NRP machine learning model 108a.

Thus, in some embodiments, the instructions of NRP module 108 may cause system 100 to apply trained NRP machine learning model 108a to the received input dialog 120, to determine a degree of influence or significance of each sentence or utterance in the input dialog 120 on the entire conversation represented in input dialog 120.

In some embodiments, determining a degree of influence or significance of each sentence or utterance in the input dialog 120 on the entire conversation is based, at least in part, on a two-step utterance removal approach. In some embodiments, in an initial step, NRP machine learning model 108a is applied to input dialog 120, to output a probability pᵣ associated with predicting a next (or prior) utterance within dialog 120, based on a corresponding context C (which may be the sequence of all utterances appearing before the target utterance). Then, in a subsequent step, dialog 120 is processed to remove one utterance sᵢ at a time from the context (C\sᵢ). NRP machine learning model 108a is again applied to the context, to output a probability associated with predicting the corresponding next (or prior) utterance within dialog 120, based on the revised context (C\sᵢ), e.g., wherein one utterance has been removed. Then, the difference (i.e., decline) in the output probabilities between the original context and the revised context predictions is assigned as an influence score to the removed utterance, wherein the greater the difference (i.e., decline), the greater influence may be attributed to the removed utterance in performing the NRP task.

The intuition behind the salient utterance identification approach is that the removal of one or more critical utterances from a dialog context will cause a decline in the predictive power of the NRP machine learning model 108a in predicting subsequent responses and/or prior utterance. Accordingly, in some embodiments, the present disclosure provides for determining a saliency of an utterance within input dialog 120 based, at least in part, on identifying utterances within input dialog 120 that are critical for the NRP task.

Accordingly, in some embodiments, the present disclosure provides for removing one utterance at a time from the dialog context (C\sᵢ) and using that revised context as the input to an NRP-FW version of NRP machine learning model 108a, to output a probability (pᵣ^{fw}) for the corresponding response (cᵣ). The difference in the probability (pᵣ−pᵣ^{fw}) may then be assigned as an influence score to the removed utterance sᵢ within the context C. In some embodiments, the same process may be followed to identify the difference (decline) in probability in predicting a prior utterance using the NRP-BW version of NRP machine learning model 108a, wherein the difference is assigned as another influence score to the removed utterance sᵢ.

In some embodiments, in step 208, the present disclosure provides for determined a salience of an utterance within dialog 120, based, at least in part, on its influence score. In some embodiments, a salience of an utterance within input dialog 120 may be based on an influence score assigned to the utterance in step 206, or on an average of two or more influence score assigned to the utterance in step 206.

In some embodiments, in step 210, the instructions of summarization module 110 may cause system 100 to generate a summary 122 of input dialog 120. In some embodiments, summary 122 may comprise one or more utterances selected from dialog 120 based, at least in part, on an influence score assigned to each of the utterances in step 208. For example, utterances may be selected for inclusion in summary 122 based, e.g., on exceeding a predetermined influence score threshold, or any other suitable selection methodology. For example, the following exemplary summary 122 represents an extractive summary of the exemplary input dialog 120 presented herein above:

| | |
|---|---|
| Customer | Flight 1234 from Miami to LaGuardia smells awful. They |
| | told us to rebook, then told us the original flight was still |
| | departing. |
| Agent | Unfortunately, our First Class Cabin is full on our 1234 |
| | flight for today, Allie. You may seek further assistance by |
| | reaching out to one of our in-flight crew members on duty. |

### Experimental Results

Method 200 of the present disclosure was evaluated in performing a dialog summarization task using a dialog dataset termed TweetSumm (available at https://github.com/guyfe/Tweetsumm, last viewed Oct. 11, 2021). The TweetSumm dataset comprises 1,100 dialogs reconstructed from Tweets that appear in the Kaggle Customer Support On Twitter dataset (see www.kaggle.com/thoughtvector/customer-support-on-twitter). Each of the dialogs is associated with 3 extractive and 3 abstractive summaries generated by human annotators. The Kaggle dataset is a large scale dataset based on conversations between consumers and customer support agents on Twitter.com. It covers a wide range of topics and services provided by various companies, from airlines to retail, gaming, music etc. Thus, TweetSumm can serve as a dataset for training and evaluating summarization models for a wide range of dialog scenarios.

The present inventors created the 1,100 dialogs comprising TweetSumm by reconstructing 49,155 unique dialogs from the Kaggle Customer Support On Twitter dataset. Then, short and long dialogs containing fewer than 6 or more than 10 utterances were filtered out, in order to focus on dialogs that are representative of typical customer care scenarios. This resulted in 45,547 dialogs with an average length of 22 sentences.

Next, in order to represent a typical two-party customer service scenario in which a single customer interacts with a single agent, dialogs with more than two speakers were removed. From the remaining 32,081 dialogs, 1,100 dialogs were randomly sampled. These dialogs were used to generate summaries manually, by human annotators. Each annotator was asked to generate one extractive and one abstractive summary for a single dialog at a time. When generating the extractive summary, the annotators were instructed to highlight the most salient sentences in the dialog. For the abstractive summaries, they were instructed to write a summary that contains one sentence summarizing what the customer conveyed and a second sentence summarizing what the agent responded. A total of 6,600 summaries were created, approx. half extractive summaries (the extractive summary dataset) and approx. half abstractive summaries (the abstractive summary dataset).

Table 2 details the average length of the dialogs in TweetSumm, including the average lengths of the customer and agent utterances.

TABLE 2
Average lengths of dialogs

| Type | Overall | Customer Side | Agent Side |
|---|---|---|---|
| Utterances | 10.17(±2.31) | 5.48(±1.84) | 4.69(±1.39) |
| Sentences | 22(±6.56) | 10.23(±4.83) | 11.75(±4.44) |
| Tokens | 245.01(±79.16) | 125.61(±63.94) | 119.40(±46.73) |

The average length of the summaries is reported in Table 3. Comparing the dialog lengths to the summaries lengths indicates the average compression rate of the summaries. For instance, on average, the abstractive summaries compression rate is 85% (i.e. the number of tokens is reduced by 85%), while the extractive summaries compression rate is 70%. The number of customer and agent sentences selected in the extractive summaries were relatively equally distributed with 7445 customer sentences and 7844 agent sentences in total.

TABLE 3
Average lengths (in # tokens) of summaries

| Type | Overall | Customer | Agent |
|---|---|---|---|
| Abstractive | 36.41(±12.97) | 16.89(±7.23) | 19.52(±8.27) |
| Extractive | 73.57(±28.80) | 35.59(±11.3) | 35.80(±18.67) |

Next, the positions of the sentences selected for the extractive summaries were analyzed. In 85% of the cases, sentences from the first customer utterance were selected, compared to 52% of the cases in which sentences from the first agent utterances were selected. This corroborates the intuition that customers immediately express their need in a typical customer service scenario, while agents do not immediately provide the needed answer: agents typically greet the customer, express empathy, and ask clarification questions. For the abstractive summaries, inherently, the utterance from which annotators selected information cannot be directly deduced, but can be approximated. In addition, for each abstractive summary, the ROUGE distance was evaluated (using ROUGE-L Recall) between the agent (resp. customer) part of the summary, with each of the actual agent (resp. customer) utterances in the original dialog. The utterance with the maximal score was considered to be the utterance on which the summary is mainly based. By averaging over all the dialogs, it was obtained that 75% of the customer summary part are based on the first customer utterance vs. only 12% of the agent's part.

The present method 200 was evaluated against the following unsupervised extractive summarization methods:
Random (extractive): Two random sentences from the agent utterances and two from the customer utterances.
LEAD-4 (extractive): The first two sentences from the agent utterances and the first two from the customer utterances are selected.
LexRank (extractive): An unsupervised summarizer (see, Günes Erkan and Dragomir R. Radev. 2004. Lexrank: Graph-based lexical centrality as salience in text summarization. J. Artif. Int. Res., 22(1):457-479) which casts the summarization problem into a fully connected graph, in which nodes represent sentences and edges represent similarity between two sentences. Pair-wise similarity is measured over the bag-of-words representation of the two sentences. Then, PowerMethod is applied on the graph, yielding a centrality score for each sentence, wherein the two top central customer and agent sentences (2+2) are selected.
Cross Entropy Summarizer (extractive): CES is an unsupervised, extractive summarizer (see, Haggai Roitman et al. Unsupervised dual-cascade learning with pseudo-feedback distillation for query-focused extractive summarization. In WWW '20: The Web Conference 2020, Taipei, Taiwan, Apr. 20-24, 2020, pages 2577-2584. ACM/IW3C2; Guy Feigenblat et al. 2017. Unsupervised query-focused multi-document summarization using the cross entropy method. In Proceedings of the 40th International ACM SIGIR Conference on Research and Development in Information Retrieval, Shinjuku, Tokyo, Japan, Aug. 7-11, 2017, pages 961-964. ACM), which considers the summarization problem as a multi-criteria optimization over the sentences space, where several summary quality objectives are considered. The aim is to select a subset of sentences optimizing these quality objectives. The selection runs in an iterative fashion: in each iteration, a subset of sentences is sampled over a learned distribution and evaluated against quality objectives. Minor tuning was introduced to the original algorithm, to suit dialog summarization. First, query quality objectives were removed since the focus is on generic summarization. Then, since dialog sentences tend to be relatively short, when measuring the coverage objective, each sentence was expanded with the two most similar sentences, using Bhattacharyya similarity. Finally, Lex-Rank centrality scores were used as an additional quality objective, by averaging the centrality scores of sentences in a sample.

### Automated Evaluations

The present inventors first used automated measures to evaluate the quality of summaries generated by method 200, as well as the baseline models described herein above, using the reference summaries of TweetSumm. Summarization quality was measured using the ROUGE measure (see, Chin-Yew Lin. 2004. Rouge: A package for automatic evaluation of summaries. In Text summarization branches out: Proceedings of the ACL-04 workshop, volume 8. Barcelona, Spain) compared to the ground truth. For the limited length variants, ROUGE was run with its limited length constraint. Table 4 below reports ROUGE F-Measure results. All summarization models were evaluated (extractive and abstractive, where the extractive summarizers are set to extract 4 sentences) against the abstractive and extractive summary datasets. Based on the average length of the summaries, reported in Table 3 above, ROUGE was evaluated with three length limits: 35 tokens (the average length of the abstractive summaries), 70 tokens (the average length of the extractive summaries) and unlimited.

The extractive summarization models were evaluated on the abstractive reference summaries. As described in Table 4 below, in most cases, except in the case of 70 token summary, the present method 200 outperforms all other unsupervised, extractive baseline models. Interestingly, the performance of the simple Lead-4 baseline is not far from that of the more complex unsupervised baseline models. For instance, considering the 70 tokens results of the abstractive summary dataset, LexRank outperforms Lead-4 by only 4%-8%. This is backed up by the intuition that salient content conveyed by the customer appears at the beginning of the dialog. To rule out any potential overfitting, results of the unsupervised, extractive, summarizers are reported against the validation set. Table 5 shows a similar trend, wherein in most cases, the present method 200 outperforms other models.

The extractive summarization models were also evaluated on the extractive summary dataset. Note that the average length of ground truth extractive summaries in TweetSumm is 4 sentences out of 22 sentences, on average, in a dialog. The lower compression rate of the extractive summaries compared to the abstractive summaries leads to higher ROUGE scores of the extractive summaries. The present method 200 model outperforms all unsupervised methods.

TABLE 4
ROUGE F-Measure evaluation on the test set

| | | | | | |
|---|---|---|---|---|---|
| Length Limit | Method Name | R-1 | R-2 | R-SU4 | R-L |

Abstractive Dataset

| | | | | | |
|---|---|---|---|---|---|
| 35 Tokens | Random | 22.970 | 6.370 | 8.340 | 10.601 |
| | Lead | 26.666 | 10.098 | 11.690 | 24.360 |
| | LexRank | 27.661 | 10.448 | 12.249 | 24.900 |
| | CES | 29.105 | 11.483 | 13.344 | 26.281 |
| | Method 200 | 30.197 | 12.119 | 13.911 | 27.111 |
| 70 Tokens | Random | 26.930 | 8.870 | 10.980 | 24.337 |
| | Lead | 28.913 | 11.489 | 13.053 | 26.395 |
| | LexRank | 30.457 | 12.379 | 14.102 | 27.486 |
| | CES | 31.465 | 13.152 | 14.954 | 28.464 |
| | Method 200 | 31.416 | 17.365 | 14.043 | 27.623 |
| Unlimited | Random | 26.865 | 8.848 | 10.946 | 24.269 |
| | Lead | 29.061 | 11.560 | 13.106 | 26.470 |
| | exRank | 30.459 | 12.652 | 14.423 | 27.563 |
| | CES | 31.569 | 13.334 | 15.118 | 28.552 |
| | Method 200 | 31.109 | 17.265 | 17.956 | 28.541 |

Extractive Summary Dataset

| | | | | | |
|---|---|---|---|---|---|
| 35 Tokens | Random | 32.761 | 17.843 | 17.794 | 30.518 |
| | Lead | 53.156 | 42.944 | 40.549 | 52.045 |
| | LexRank | 48.584 | 36.758 | 36.125 | 46.847 |
| | CES | 55.328 | 45.032 | 43.841 | 54.182 |
| | Method 200 | 58.410 | 49.490 | 47.404 | 57.428 |
| 70 Tokens | Random | 47.868 | 32.978 | 32.693 | 46.035 |
| | Lead | 57.491 | 47.199 | 45.388 | 56.531 |
| | LexRank | 55.773 | 43.365 | 42.563 | 54.290 |
| | CES | 58.984 | 47.713 | 46.387 | 57.889 |
| | Method 200 | 61.114 | 51.381 | 49.558 | 60.292 |
| Unlimited | Random | 48.943 | 35.074 | 34.548 | 47.333 |
| | Lead | 54.995 | 44.425 | 42.796 | 53.943 |
| | LexRank | 57.018 | 45.332 | 44.459 | 55.772 |
| | CES | 59.872 | 49.126 | 47.722 | 58.874 |
| | Method 200 | 62.971 | 55.411 | 54.614 | 62.596 |

TABLE 5
ROUGE F-Measure on validation set

| | | | | | |
|---|---|---|---|---|---|
| Length Limit | Method Name | R-1 | R-2 | R-SU4 | R-L |

Abstractive Summary Dataset

| | | | | | |
|---|---|---|---|---|---|
| 35 Tokens | Random | 24.459 | 7.719 | 9.504 | 22.157 |
| | Lead | 28.569 | 11.623 | 13.058 | 26.088 |
| | LexRank | 27.039 | 10.110 | 12.030 | 23.990 |
| | CES | 30.693 | 13.129 | 14.752 | 27.606 |
| | Method 200 | 30.889 | 13.410 | 14.901 | 27.890 |
| 70 Tokens | Random | 28.249 | 10.480 | 12.277 | 25.711 |
| | Lead | 31.127 | 13.536 | 14.867 | 28.542 |
| | LexRank | 30.302 | 12.444 | 14.161 | 27.191 |
| | CES | 32.769 | 14.125 | 15.650 | 29.516 |
| | Method 200 | 32.453 | 14.694 | 15.316 | 29.119 |

All the techniques, parameters, and other characteristics described above with respect to the experimental results are optional embodiments of the invention.

The present invention may be a computer system, a computer-implemented method, and/or a computer program product. The computer program product may include a computer readable storage medium (or media) having computer readable program instructions thereon for causing a hardware processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 10% deviation (namely, ±10%) from that value. Similarly, when such a term describes a numerical range, it means up to a 10% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least One hardware processor; and
a non-transitory computer-readable storage medium having stored thereon program instructions, the program instructions executable by the at least one hardware processor to:
receive, as input, a two-party multi-turn dialog,
apply a trained next response prediction (NRP) machine learning model to the received dialog, to determine a level of significance of each utterance in said dialog with respect to performing an NRP task over said dialog,
assign a score to each of said utterances in said dialog, based, at least in part, on said determined level of significance, and
select one or more of said utterances for inclusion in an extractive summarization of said dialog, based, at least in part, on said assigned scores.

2. The system of claim 1, wherein said dialog represents a conversation between a customer and a customer care agent.

3. The system of claim 1, wherein said NRP task comprises predicting, from a provided set of candidate utterances, one of:
(i) a next utterance at a specified point in said dialog, based on an input dialog context comprising a sequence of utterances appearing in said dialog before said specified point; and
(ii) a previous utterance at a specified point in said dialog, based on an input dialog context comprising a sequence of utterances appearing in said dialog after said specified point.

4. The system of claim 3, wherein said predicting is associated with a probability.

5. The system of claim 4, wherein, with respect to an utterance of said utterances, said level of significance is determined by calculating a difference between (i) said probability associated with said predicting when said utterance is included in said dialog context, and (ii) said probability associated with said predicting when said utterance is excluded from said dialog context.

6. The system of claim 1, wherein said selecting comprises selecting said utterances having a score exceeding a specified threshold.

7. The system of claim 1, wherein said NRP machine learning model is trained on a training dataset comprising a plurality of entries, wherein each of said entries comprises:
(i) a dialog context comprising a sequence of utterances appearing in a dialog prior to specified point;
(ii) a candidate next utterance; and
(iii) a label indicating whether said candidate next utterance is the correct next utterance in said dialog.

8. A computer-implemented method comprising:
receiving, as input, a two-party multi-turn dialog;
applying a trained next response prediction (NRP) machine learning model to the received dialog, to determine a level of significance of each utterance in said dialog with respect to performing an NRP task over said dialog;
assigning a score to each of said utterances in said dialog, based, at least in part, on said determined level of significance; and
selecting one or more of said utterances for inclusion in an extractive summarization of said dialog, based, at least in part, on said assigned scores.

9. The computer-implemented method of claim 8, wherein said dialog represents a conversation between a customer and a customer care agent.

10. The computer-implemented method of claim 8, wherein said NRP task comprises predicting, from a provided set of candidate utterances, one of:
(i) a next utterance at a specified point in said dialog, based on an input dialog context comprising a sequence of utterances appearing in said dialog before said specified point; and
(ii) a previous utterance at a specified point in said dialog, based on an input dialog context comprising a sequence of utterances appearing in said dialog after said specified point.

11. The computer-implemented method of claim 10, wherein said predicting is associated with a probability.

12. The computer-implemented method of claim 11, wherein, with respect to an utterance of said utterances, said level of significance is determined by calculating a difference between (i) said probability associated with said predicting when said utterance is included in said dialog context, and (ii) said probability associated with said predicting when said utterance is excluded from said dialog context.

13. The computer-implemented method of claim 8, wherein said selecting comprises selecting said utterances having a score exceeding a specified threshold.

14. The computer-implemented method of claim 8, wherein said NRP machine learning model is trained on a training dataset comprising a plurality of entries, wherein each of said entries comprises:
(i) a dialog context comprising a sequence of utterances appearing in a dialog prior to specified point;
(ii) a candidate next utterance; and
(iii) a label indicating whether said candidate next utterance is the correct next utterance in said dialog.

15. A computer program product comprising a non-transitory computer-readable storage medium having program instructions embodied therewith, the program instructions executable by at least one hardware processor to:
receive, as input, a two-party multi-turn dialog;
apply a trained next response prediction (NRP) machine learning model to the received dialog, to determine a level of significance of each utterance in said dialog with respect to performing an NRP task over said dialog;
assign a score to each of said utterances in said dialog, based, at least in part, on said determined level of significance; and
select one or more of said utterances for inclusion in an extractive summarization of said dialog, based, at least in part, on said assigned scores.

16. The computer program product of claim 15, wherein said dialog represents a conversation between a customer and a customer care agent.

17. The computer program product of claim 15, wherein said NRP task comprises predicting, from a provided set of candidate utterances, one of:
(i) a next utterance at a specified point in said dialog, based on an input dialog context comprising a sequence of utterances appearing in said dialog before said specified point; and
(ii) a previous utterance at a specified point in said dialog, based on an input dialog context comprising a sequence of utterances appearing in said dialog after said specified point.

18. The computer program product of claim 17, wherein said predicting is associated with a probability.

19. The computer program product of claim 18, wherein, with respect to an utterance of said utterances, said level of significance is determined by calculating a difference between (i) said probability associated with said predicting when said utterance is included in said dialog context, and (ii) said probability associated with said predicting when said utterance is excluded from said dialog context.

20. The computer program product of claim 15, wherein said NRP machine learning model is trained on a training dataset comprising a plurality of entries, wherein each of said entries comprises:
(i) a dialog context comprising a sequence of utterances appearing in a dialog prior to specified point;
(ii) a candidate next utterance; and
(iii) a label indicating whether said candidate next utterance is the correct next utterance in said dialog.
